(19) United States
(12) Patent Application Publication
(10) Pub. No.: US 2004/0201141 A1
(43) Pub. Date: Oct. 14, 2004

(54) Apparatus and process for synthesis of carbon nanotubes or carbon nanofibers using flames

(76) Inventors: Jongsoo Jurng, Seoul (KR); Gyo Woo Lee, Seoul (KR); Jungho Hwang, Seoul (KR); Gwi-Nam Bae, Seoul (KR)

Correspondence Address: JONES DAY, 222 EAST 41ST ST, NEW YORK, NY, 10017, US

(21) Appl. No.: 10/822,521

(22) Filed: Apr. 12, 2004

(30) Foreign Application Priority Data
Apr. 12, 2003 (KR) 10-2003-23179

(51) Int. Cl. F27B 7/32

(52) U.S. Cl. 266/186

(57) ABSTRACT

An apparatus for synthesizing a carbon nano-material is provided with a reaction gas supplier for supplying a reaction gas in isolation from atmospheric condition, a metallic catalyst supplier for supplying a metallic catalyst in isolation from atmospheric condition, a reactor communicating with the reaction gas supplier and the metallic catalyst supplier and providing a space for synthesis of the carbon nano-material, a heater, positioned outside the reactor, for heating the reactor to a temperature proper for the synthesis of the carbon nano-material, and a collector for collecting the carbon nano-material generated in the reactor.

### FIELD OF THE INVENTION

The present invention relates to an apparatus for generating carbon nano-materials and, more particularly, to an apparatus for synthesizing carbon nano-materials, such as carbon nanotubes or carbon nanofibers, wherein the carbon nano-material is synthesized from reactants in a quartz reactor and the heat necessary for the reaction is provided by combustions occurring outside the quartz reactor.

### BACKGROUND OF THE INVENTION

A carbon nanotube is composed of a plurality of cylindrically rolled graphite sheets that are arranged telescopically. The diameter of the cylindrical shape ranges from several nanometers to a hundred nanometers and the length is a dozen times through a thousand times as long as the diameter.

Carbon nanotubes may be classified into a single wall nanotube, a multi-wall nanotube, and a rope nanotube, in terms of the form of the rolled graphite sheets. They have various electrical characteristics that are determined according to the roll angle of the graphite sheet. For example, that carbon nanotubes have an electrical conductivity when in an armchair configuration has been known. Further, carbon nanotubes have the characteristic of a semiconductor when formed in a zigzag configuration.

Carbon nano-materials, including carbon nanotubes with the characteristics described above, carbon nanofibers, etc., are chemically stable with excellent electrical characteristics and high mechanical strength. Therefore, they are expected to be widely applied in the information and technology industry in a variety of manners.

Prior art apparatuses for synthesizing such carbon nano-materials, especially, carbon nanotubes, use an arc discharge method. The arc discharge method needs considerably many components to synthesize the carbon nano-materials, such as a vacuum vessel, an insulation chamber, an arc-generating unit, etc. For this reason, prior art apparatuses for synthesizing carbon nanotube are significantly complex and expensive. Further, since prior art apparatuses use electrical energy for the heat source, they have poor productivity in producing carbon nano-materials. In particular, since the carbon electrodes have to be periodically exchanged, configuring an automated, continuous processes for manufacturing carbon nano-materials is difficult. Therefore, a need exists for using a heat source other than electrical energy.

### SUMMARY OF THE INVENTION

It is, therefore, an object of the present invention to provide an apparatus for synthesizing carbon nano-materials such as carbon nanotubes or carbon nanofibers, wherein the carbon nano-material is synthesized from reactants in a quartz reactor and the heat necessary for the reaction is provided by combustions occurring outside the quartz reactor.

Consistent with the foregoing objects, and in accordance with the invention as embodied broadly described herein, an apparatus for synthesizing carbon nano-material is disclosed in one embodiment of the present invention, comprising: a reaction gas supplier for supplying a reaction gas in isolation from atmospheric condition, a metallic catalyst supplier for supplying a metallic catalyst in isolation from atmospheric condition, a reactor communicating with the reaction gas supplier and the metallic catalyst supplier and providing a space for synthesis of the carbon nano-material, a heater, positioned outside the reactor, for heating the reactor to a temperature proper for the synthesis of the carbon nano-material, and a collector for collecting the carbon nano-material generated in the reactor.

The above and other objects and features of the present invention will become more apparent from the following description of the preferred embodiments given in conjunction with the accompanying drawings.

### BRIEF DESCRIPTION OF DRAWINGS

Understanding that these drawings depict only typical embodiments of the invention and are, therefore, not to be considered limiting of its scope, the invention will be described with additional specificity and detail through use of the accompanying drawings:

FIG. 1A shows a schematic of a metallic catalyst supplier used in a first embodiment of the present invention;

FIG. 1B shows a schematic of a metallic catalyst supplier used in a second embodiment of the present invention;

FIG. 2 illustrates a schematic of an apparatus for synthesis of carbon nano-materials in accordance with the first embodiment;

FIG. 3 illustrates a schematic of an apparatus for synthesis of carbon nano-materials in accordance with the second embodiment;

FIG. 4 depicts a perspective view of burners and a reactor used in a third embodiment of the present invention;

FIG. 5 depicts a sectional view of a surface flame burner; and

FIG. 6 is a schematic of a collector.

### DETAILED DESCRIPTION OF THE PRESENT INVENTION

The presently preferred embodiments of the invention will be best understood by reference to the drawings, wherein like parts or steps are designated by like numerals throughout.

The term “carbon nano-material,” used throughout the description, represents materials containing carbon, with a diameter of several nanometers through a hundred nanometers, such as carbon nanotubes and carbon nanofibers.

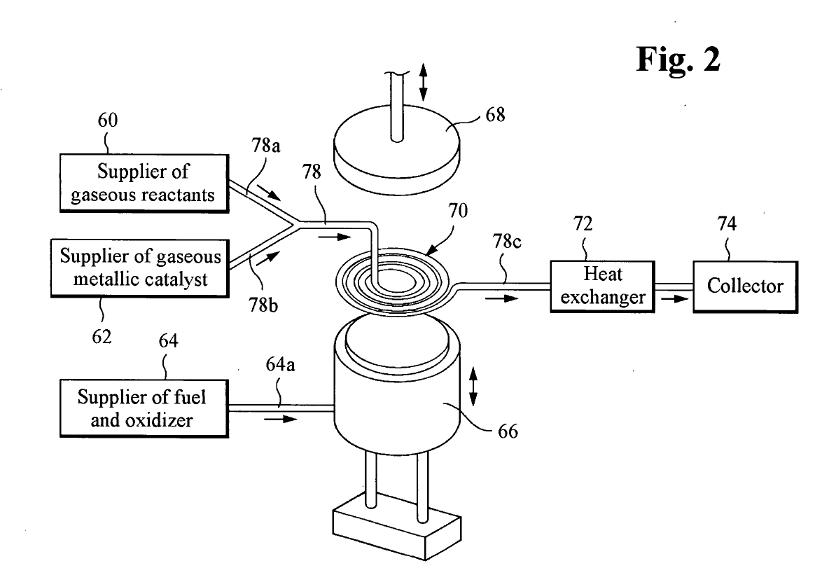

FIG. 2 is a schematic of an apparatus for synthesizing carbon nano-materials in accordance with a first embodiment of the present invention.

An apparatus is provided with reaction gas supplier 60, metallic catalyst supplier 62, reflector 68, reactor 70, burner 66, heat exchanger 72, and collector 74.

Reaction gas supplier 60 serves to supply to reactor 70 the carbon source material necessary for synthesis of the carbon nano-material. Reaction gas supplier 60 is connected to main supply tube 78 via supply tube 78a, and main supply tube 78 connected to reactor 70. Gaseous hydrocarbons, such as methane, ethylene, acetylene, carbon monoxide, cyclohexane, benzene and xylene, are used as carbon source materials. Gas cylinder for storing hydrocarbon under pressure may be used as reaction gas supplier 60.

Metallic catalyst supplier 62 serves to supply metallic catalyst necessary for synthesis of the carbon nano-material to reactor 70. Metallic catalyst supplier 62 is connected to main supply tube 78 via a supply tube 78b. Metal nitrate such as Fe(No₃)₃, and Ni(NO₃)₂ is used as the metallic catalyst. Organic metallic compound such as Fe(CO)₅, CO₂(CO)₈, (C₅H₅)₂Fe and Ni(CO)₅ is available as the metallic catalyst source. In case of source material that is hardly evaporated by only an evaporator, e.g., (C₅H₅)₂Fe, a separate sublimer (not shown) may be used to help its evaporation for the metallic catalyst in gaseous state.

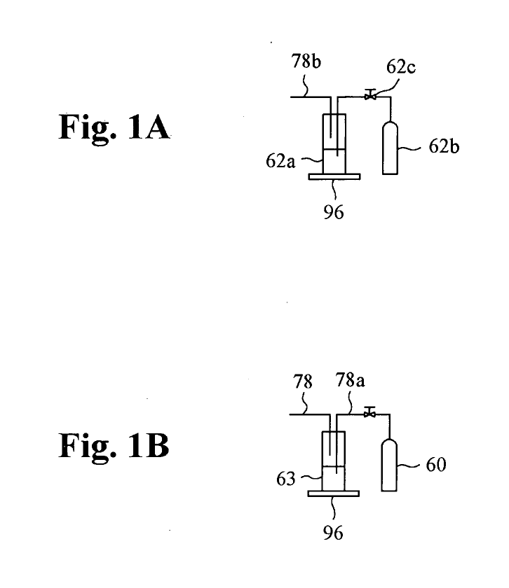

As shown in FIG. 1A, metallic catalyst supplier 62 may be embodied with a carrier gas supplier 62b and evaporator 62a containing the metallic catalyst source material. Evaporator 62a is connected to carrier gas supplier 62b through flow rate control valve 62c. Metallic catalysts in a solid or liquid state are accommodated in evaporator 62a as the metallic catalyst source material and are heated for evaporation by heater 96 positioned in a lower portion of evaporator 62a. Heater 96 may be embodied with “a hot plate,” for example. Flow rate control valve 62a functions to adjust the flow rate of the carrier gas being supplied to evaporator 62a. Inert gas such as argon (Ar) may be employed as the carrier gas. In case argon gas is employed as the carrier gas, carrier gas supplier 62b may be embodied with a general gas cylinder that contains argon under pressure. The metallic catalyst evaporated in evaporator 62a is carried toward main supply tube 78 and, hence, reactor 70 by the carrier gas.

Gases supplied from reaction gas supplier 60 and metallic catalyst supplier 62 are mixed in main supply tube 78 to be fed to reactor 70. Main supply tube 78 is preferably made of quartz.

In a first embodiment of the present invention, reactor 70 is a tube made of quartz and extending in a helical shape. The helical shape of reactor 70 enables more portions of reactor 70 to be exposed to a flame provided by burner 66, which will be discussed later. As a result, the reaction gas and the metallic catalyst are put under an environment for synthesis of carbon nano-materials, for a longer period of time, by traversing helical shaped reactor 70.

In the first embodiment, burner 66 is mounted under reactor 70, while reflector 68 is mounted above reactor 70.

Burner 66 serves to heat reactor 70 to maintain an optimal temperature in reactor 70, at which much carbon nano-material is synthesized. The optimal temperature preferably ranges from 800° C. to 1000° C. Fuel and oxidizer supplier 64 supplies fuel and oxidizer, which are needed for combustion, to burner 66 through supply tube 64a. Preferably, fuel whose quantity of heat can be easily controlled is used. In particular, LNG or LPG is preferable. Oxygen is the preferable oxidizer.

The quantity of heat provided by burner 66 has to be finely adjusted in order to form the optimal temperature in reactor 70. The quantity of heat may be adjusted by adjusting the amount of the fuel and the oxidizer being supplied to burner 66 or by changing the distance between burner 66 and reactor 70. Burner 66 is movable in a direction indicated by the arrow, so that burner 66 and reactor 70 get closer to or get more distant from each other. In the first embodiment, since reactor 70 has a helical shape close to a circular shape, burner 66 should preferably have a circular cross-section to result in a circular shaped flame. Examples of commercial burners appropriate to the present invention will be discussed in detail later.

Reflector 68 is positioned opposite to burner 66 about reactor 70 to reflect heat provided by burner 66 toward reactor 70. Reflector 68 is preferably movable in a direction indicated by the arrow, so that the distance between reflector 68 and reactor 70 can be changed.

Heat exchanger 72 cools the synthesized carbon nano-material escaping from reactor 70. A water-cooling heat exchanger using water as cooling media is preferred. The use of heat exchanger 72 may be optional. In case the produced carbon nano-material has a temperature appropriate to the processes in collector 74 at the time of its arriving at collector 74, heat exchanger 72 may be unnecessary. In particular, when supply tube 78c has sufficient length, a separate heat exchanger is not necessary since the products of the carbon nano-material are cooled in the course of travel from reactor 70 to collector 74.

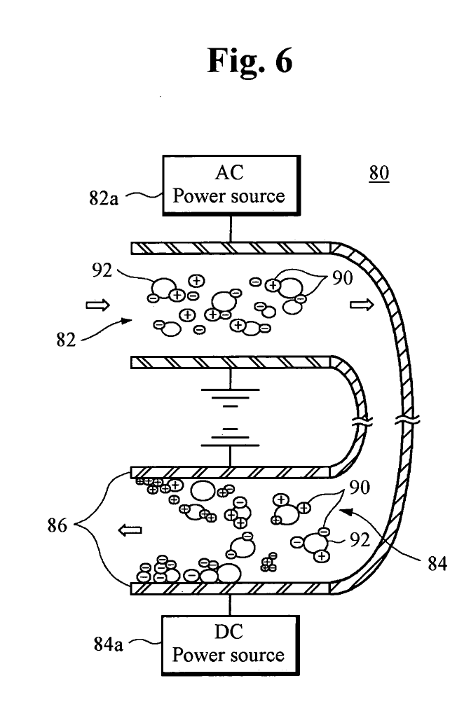

Collector 74 collects the products of the carbon nano-material using electrostatic precipitation. Detailed description about collector 74 will be given later with reference to FIG. 6.

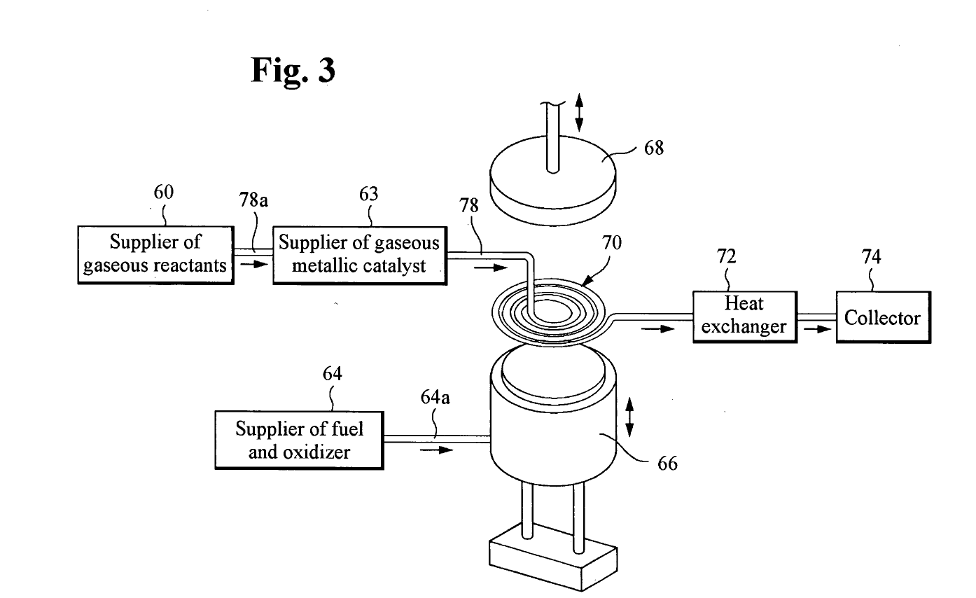

FIG. 3 shows a schematic of an apparatus for synthesizing carbon nano-materials in accordance with a second embodiment of the present invention, wherein like parts or components with those shown in the first embodiment are designated with same reference numerals and description for those will be omitted.

Unlike the first embodiment where the reaction gas and the metallic catalyst are separately supplied to and mixed in main supply tube 78, in the second embodiment, the reaction gas is directed to metallic catalyst supplier 63 via supply tube 78a and then mixed with the metallic catalyst in metallic catalyst supplier 63.

As shown in FIG. 1B, metallic catalyst supplier 63 may be embodied with only an evaporator and reaction gas supplier 60 may be embodied with a gas cylinder for storing the reaction gas under pressure. In metallic catalyst supplier 63, the metallic catalyst in a gaseous state is generated from the metallic catalyst source in a liquid state through evaporation and mixed with the reaction gas supplied from reaction gas supplier 60. The reaction gas functions as the carrier gas that carries the mixed gases to main supply tube 78 and, hence, reactor 70, in the second embodiment.

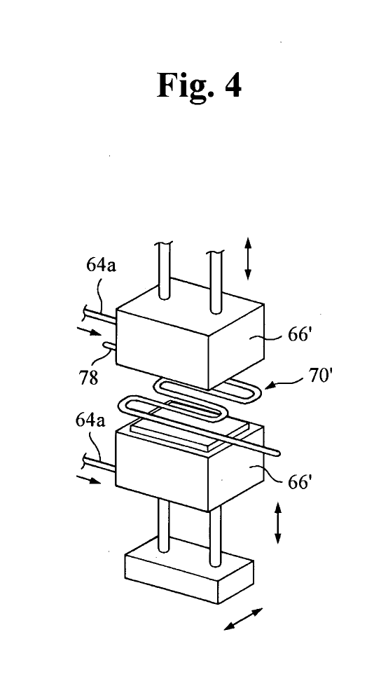

FIG. 4 shows an apparatus for synthesizing carbon nano-materials in accordance with a third embodiment. Like parts or components with those shown in the first and second embodiments are designated with like reference numerals and description for those will be omitted.

In the third embodiment, reactor 70′ extends in a zigzag form and is made of quartz. Pair of burners 66′ are provided above and under reactor 70′. Burners 66′ are preferably identical in shape and have a rectangular shape capable of covering the whole area of zigzag reactor 70′.

Burners 66′ are movable in a direction indicated by the arrows, so that burners 66′ get closer toward or more distant from reactor 70′. With this configuration, the quantity of heat to be provided to reactor 70′ may be easily adjusted.

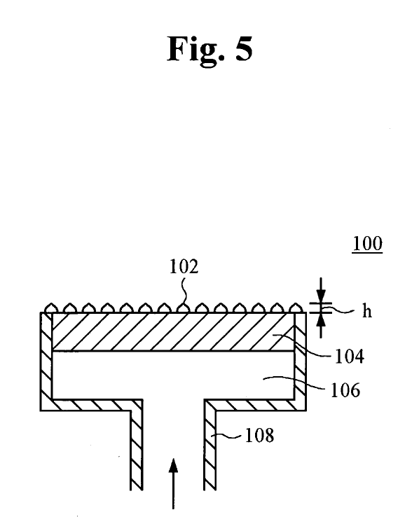

FIG. 5 illustrates one example of a burner, i.e., surface flame burner 100, applicable to the present invention. Surface flame burner 100 provides a pre-mixed flat flame or partially pre-mixed flat flame that ensures good radiant heat transfer, generating less impurities.

Surface flame burner 100 is provided with main body 108 and mat 104. As shown by the arrow, a mixture of fuel gas and oxidizer is introduced from a central lower portion of main body 108, at a constant flow speed. The mixture is burnt in the course of passing through gas permeable mat 104. In combustion, length h of the flame depends on the flow speed of the mixture. Mat 104 is made of a metal fiber with porosity. Various commercial mats can be applied to the present invention. Further, as various commercial burners are known, those skilled in the art will recognize that any type of burner capable of providing the pre-mixed flat flame or partially pre-mixed flat flame is applicable to the present invention.

FIG. 6 depicts one example of a collector using an electrostatic precipitating method. Collector 80 is provided with charging unit 82 and separation unit 84.

In charging unit 82, communicating with reactor 70, a streamer of plasma having low temperature is established. Large amounts of ions are generated in the streamer by applying an alternating current provided by AC power source 82a. When carbon nano-material 92, synthesized in reactors 70 or 70′, arrives at charging unit 82, it is positively or negatively charged by distributed ions 90.

In separation unit 84, communicating with charging unit 82, another electric field is established by a direct current between a pair of collecting plates 86. Collecting plates 86 are connected to DC power source 84a, and, therefore, have different electric polarities from each other. When charged carbon nano-material 92 arrives at separation unit 84 after leaving charging unit 82, it is attracted to collecting plate 86 that has a polarity opposite to its own polarity and adheres thereto. Next, carbon nano-material 92, adhered to collecting plate 86, is separated from collecting plate 86 by, e.g., scratching and then purified through a filter.

Since heat needed to synthesize the carbon nano-materials is provided by combustion of fuel in a gaseous or liquid state, the inventive apparatus for synthesizing carbon nano-materials may be manufactured at a more reasonable price due to its simple configuration, as compared to the prior art using electric energy.

Further, since the space in which the synthesis of the carbon nano-material occurs and the space in which the combustion by the burner occurs are closed off from each other, impurities generated by the combustion will not contaminate the products.

Further, the inventive apparatus for synthesizing carbon nano-materials can be operated continuously without interruption. Therefore, the inventive apparatus is suitable for mass production of carbon nano-materials.

What is claimed is:

1. An apparatus for synthesizing a carbon nano-material, comprising:
a reaction gas supplier for supplying a reaction gas in isolation from atmospheric condition;
a metallic catalyst supplier for supplying a metallic catalyst in isolation from atmospheric condition;
a reactor communicating with the reaction gas supplier and the metallic catalyst supplier and providing a space for synthesis of the carbon nano-material;
a heating means, positioned outside the reactor, for heating the reactor to a temperature proper for the synthesis of the carbon nano-material; and
a collecting means for collecting the carbon nano-material generated in the reactor.

2. The apparatus of claim 1, wherein the reaction gas is methane, ethylene, acetylene, carbon monoxide, cyclohexane, benzene, or xylene.

3. The apparatus of claim 1, wherein the metallic catalyst is metal nitrate.

4. The apparatus of claim 1, wherein the reactor is a tube made of quartz.

5. The apparatus of claim 1, wherein the heating means is a surface flame burner.

6. The apparatus of claim 1, further comprising a reflector for reflecting heat provided by the heating means toward the reactor.

7. The apparatus of claim 1 or 4, wherein the reactor extends in a helical form.

8. The apparatus of claim 1 or 4, wherein the reactor extends in a zigzag form.

9. The apparatus of claim 1, wherein the collecting means further comprises:
a charging unit communicating with the reactor, in which the produced carbon nano-material is electrically charged; and
a separation unit communicating with the charging unit, provided with a pair of plates, which are connected to a direct current power source, wherein each of the plates has an electric polarity different from each other.
